(19) United States
(12) Patent Application Publication
(10) Pub. No.: US 2006/0089145 A1
(43) Pub. Date: Apr. 27, 2006

(54) Wireless vehicle-specific data management

(76) Inventors: Infon Chen, Plano, TX (US); Yun-Ping Chu, Plano, TX (US)

Correspondence Address: SLATER & MATSIL, L.L.P., 17950 PRESTON RD, SUITE 1000, DALLAS, TX, 75252-5793, US

(21) Appl. No.: 10/974,320

(22) Filed: Oct. 27, 2004

(51) Int. Cl. H04Q 7/20; G01S 1/00

(52) U.S. Cl. 455/445; 455/426.2

(57) ABSTRACT

System and method for providing vehicle-specific data to vehicles is provided. A preferred embodiment comprises downloading vehicle-specific data to mass-transit vehicles when vehicles are within a predetermined area, such as a garage, parking lot, gas station, or the like, via a wireless interface, such as a WiFi communications link. The vehicle-specific information may include route information, advertising information, or the like. In a preferred embodiment, the information is encrypted and compressed for transmission by an application server and decrypted and decompressed upon receipt. The data may also be divided into multiple blocks for transmission and reassembled upon receipt. Data integrity checks may be performed for each block and for the entire message.

### TECHNICAL FIELD

The present invention relates generally to a system and method for providing data to one or more vehicles, and more particularly to a system and method for providing vehicle-specific data wirelessly to one or more vehicles.

### BACKGROUND

Mass-transit vehicles, e.g., buses, trains, subways, and the like, typically provide economical and efficient transportation to a group of commuters from a first point to a second point. The destination and/or route is frequently displayed on the vehicle to notify commuters as to the destination of a particular vehicle. The destination or route may be imprinted on a roll or block from which the driver or operator selects the appropriate destination or route for each particular bus. In more modern vehicles, the route or destination may be displayed on an electronic board, which may be placed, for example, on the front of the vehicle, along a side of the vehicle, inside the vehicle, or the like.

In these more modern vehicles, the route or destination may either be entered manually by an operator or manually downloaded from a device to a controller on the bus. For example, some systems allow an operator such as a bus driver to enter information to be displayed via a keypad or other input device located on the bus. The information is then displayed to the commuters. As another example, some systems allow route and/or destination information to be downloaded from another device, such as a laptop, to a controller on the vehicle. In this case, the operator must physically connect the downloading device to the controller of each vehicle. Once downloaded, the operator is frequently given the ability to select the appropriate information to be displayed and to enter other information from an operator console.

These methods, however, are labor intensive, error prone, and expensive. For example, requiring the operator to enter the appropriate route and/or destination information may take considerable time because a single route may require multiple messages for different portions of the route. Furthermore, the operator may easily make mistakes in spelling, ordering of the messages, content of the messages, and the like.

Downloading information from another device, e.g., a laptop computer, is also inefficient. Generally, this type of system requires an individual to physically go to each vehicle, manually connect a cable between the downloading device to a controller on the vehicle, and perform commands to download the information to the controller on the vehicle. This is a formidable task in a large metropolitan area that may have hundreds of buses, each bus requiring updated information.

Thus, what is needed is a system and method for providing vehicle-specific information in an easy and efficient manner.

### SUMMARY OF THE INVENTION

These and other problems are generally solved or circumvented, and technical advantages are generally achieved, by preferred embodiments of the present invention which provides a system and method for providing vehicle-specific data wirelessly to one or more vehicles

In accordance with a preferred embodiment of the present invention, a method for providing vehicle-specific information to a mass-transit vehicle is provided. The method comprises determining whether or not the mass-transit vehicle is within a first area, e.g., a garage, parking lot, gas station, or the like. Information is retrieved from a database and transmitted to the mass-transit vehicle. The information may be transmitted to the mass-transit vehicle in blocks and contain error detection and correction data.

In accordance with another preferred embodiment of the present invention, a system for providing vehicle-specific information to a mass-transit vehicle is provided. The system comprises an application server that transmits data to a remote unit installed on a vehicle, such as a mass transit vehicle. The remote unit receives vehicle-specific information and interfaces with an operator control unit to display the relevant information. The remote unit may also interface directly with a display.

Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a network diagram incorporating features of an embodiment of the present invention;

FIG. 2 is a block diagram of an application server in accordance with an embodiment of the present invention;

FIG. 3 is a block diagram of a remote unit in accordance with an embodiment of the present invention;

FIG. 4 is a message flow diagram in accordance with an embodiment of the present invention;

FIG. 5 is a message format that may be transmitted by the application server to the remote unit in accordance with an embodiment of the present invention;

FIG. 6 is a data flow diagram of a process that may be performed by the remote unit to receive data from the application server in accordance with an embodiment of the present invention; and

FIG. 7 is a data flow diagram of a process that may be performed by the remote unit to conserve power in accordance with an embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely providing vehicle-specific information to a bus. The invention may also be applied, however, to other vehicles, particularly to other mass-transit vehicles such as trains, subways, and the like.

It should be noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

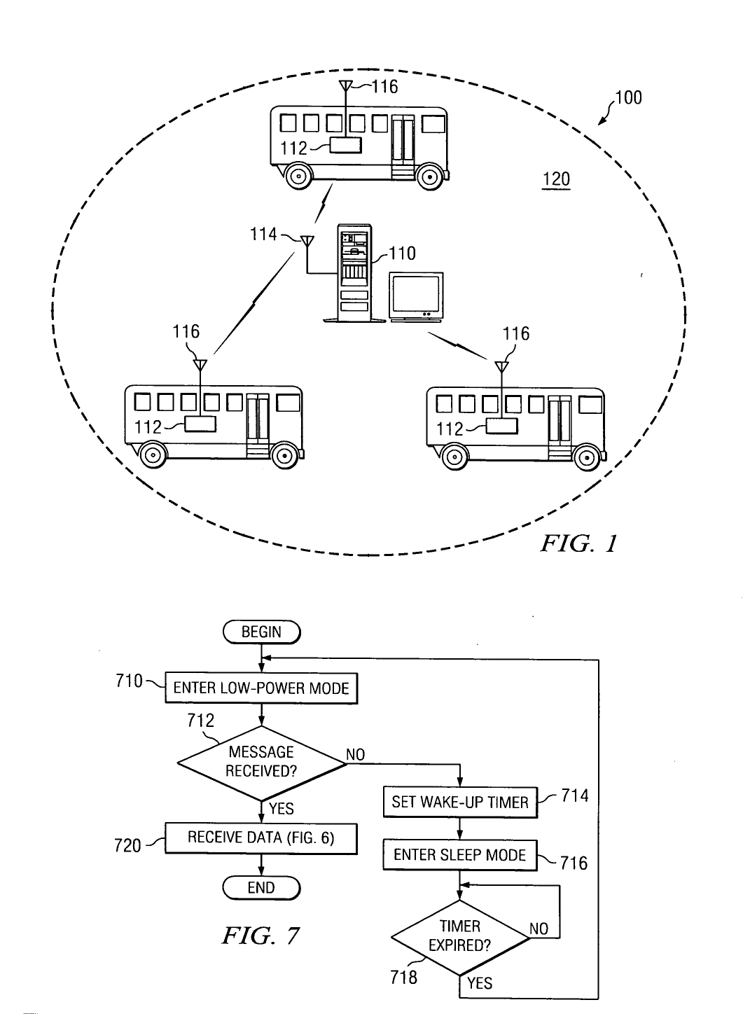

Referring now to FIG. 1, reference numeral 100 designates a network diagram of a portion of a wireless network embodying features of an embodiment of the present invention. It should be noted that one of ordinary skill in the art will realize that the network diagram 100 has been simplified to better illustrate features of the present invention. Well-known elements have not been shown, but are nonetheless part of a network embodying features of the present invention. For example, a network embodying the present invention may include amplifiers, power supplies, maintenance systems, gateways, routers, firewalls, and the like.

The network 100 comprises an application server 110 and a mobile control unit 112, which is shown as being mounted in a mass-transit vehicle such as a bus. Each of the application server 110 and the mobile control unit 112 is communicatively coupled to antennas 114 and 116, respectively. The application server 110 may comprise a general purpose computing device, such as a personal computer, a mini-computer, a main frame, a personal data assistant, a laptop computer, or the like, configured to communicate wirelessly to the mobile control unit 112 via a wireless communications technology.

In a preferred embodiment, the application server 110 may communicate to the mobile control unit 112 via a WiFi communications link. A WiFi communications link is generally utilized as a wireless LAN and has a limited range, indicated by the dotted circle 120 in FIG. 1. In this embodiment, the application server 110 may be located at a central location, such as a garage, parking area, gas station, or some other common location in which the mass-transit vehicles are routinely located. In other embodiments, however, the application server 110 and/or the antenna 114 may be located at a plurality of locations.

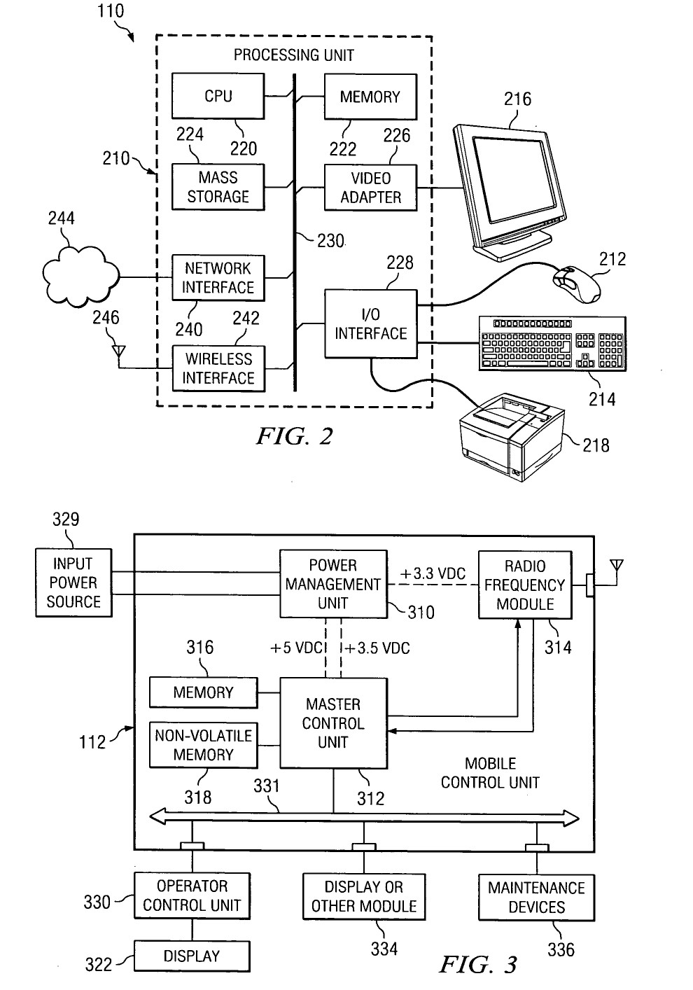

The application server 110 is discussed in greater detail below with reference to FIG. 2, and the mobile control unit 112 is discussed in greater detail below with reference to FIG. 3.

Generally, embodiments of the present invention may be utilized to provide information to vehicles, and in a preferred embodiment, the present invention is utilized to provide vehicle-specific information to mass-transit vehicles, such as the buses illustrated in FIG. 1. In this embodiment, the vehicle-specific information may include route or destination information, advertising customized for a particular route or vehicle, or the like. A system operator (not shown) determines the information and directs the application server 110 to transmit the vehicle-specific information to the mobile control unit 112 when the mobile control unit 112 is available.

FIG. 2 is a block diagram of an application server 110 that may be used in accordance with an embodiment of the present invention. The application server 110 may comprise a processing unit 210, such as a desktop computer, a workstation, a laptop computer, a personal digital assistant, a dedicated unit customized for a particular application, equipped with one or more input device, such as a mouse 212, a keyboard, 214, or the like, and one or more output devices, such as a display 216, a printer 218, or the like. The processing unit 210 may include a central processing unit (CPU) 220, memory 222, a mass storage device 224, a video adapter 226, and an 1/0 interface 228 connected to a bus 230.

The bus 230 may be one or more of any type of several bus architectures including a memory bus or memory controller, a peripheral bus, video bus, or the like. The CPU 220 may comprise any type of electronic data processor. For example, the CPU 220 may comprise a Pentium™ processor from Intel Corp., an Athlon processor from Advanced Micro Devices, Inc., a Reduced Instruction Set Computer (RISC), or the like. The memory 222 may comprise any type of system memory such as static random access memory (SRAM), dynamic random access memory (DRAM), synchronous DRAM (SDRAM), read-only memory (ROM), a combination thereof, or the like. In an embodiment, the memory 222 may include ROM for use at boot-up, and DRAM for data storage for use while executing programs.

The mass storage device 224 may comprise any type of storage device configured to store data, programs, and other information and to make the data, programs, and other information accessible via the bus 230. The mass storage device 224 may comprise, for example, one or more of a hard disk drive, a magnetic disk drive, an optical disk drive, or the like.

The video adapter 226 and the I/O interface 228 provide interfaces to couple external input and output devices to the processing unit 210. As illustrated in FIG. 2, examples of input and output devices include the display 216 coupled to the video adapter 226 and the mouse 212, keyboard 214, and printer 218 coupled to the I/O interface 228. Other devices may be coupled to the processing unit 210, and additional or fewer interface cards may be utilized. For example, a serial interface card (not shown) may be used to provide a serial interface for a printer.

The processing unit 210 also preferably includes a network interface 240 and a wireless interface 242. The network interface 240 allows the processing unit 210 to communicate with remote units via a network 244. In an embodiment, the processing unit 210 is coupled to a local-area network or a wide-area network to provide communications to remote devices, such as other processing units, the Internet, or the like. In this manner, the vehicle-specific information may be determined remotely and downloaded to the processing unit 210 for transmission to the mobile control unit 112 (FIG. 1). The network interface 240 may provide an interface for a wired link, such as an Ethernet cable or the like, or a wireless link.

The wireless interface 242 allows the processing unit 210 to communicate with other devices via a transmitter 246 and a wireless communications channel. As discussed above with reference to FIG. 1, the application server 110 communicates via a wireless communications channel with a mobile control unit 112, which may be located on a vehicle (see FIG. 1). The wireless interface 242 allows the processing unit 210 to communicate to the mobile control unit 112 via a wireless communications channel, transmitting information such as commands, route information, advertising, service information, or the like and receiving acknowledgement information, status information, or the like. In a preferred embodiment, the application server 110 is configured to communicate wirelessly to one or more mobile control unit 112 via a wireless LAN (WLAN) protocol such as 801.11b, 801.11g, or the like.

It should be noted that the application server 110 may include other components. For example, the application server 110 may include power supplies, cables, a motherboard, removable storage media, cases, and the like. These other components, although not shown, are considered part of the application server 110.

FIG. 3 is a block diagram of a mobile control unit 112 in accordance with an embodiment of the present invention. In an embodiment, the mobile control unit 112 includes a power management unit 310, a master control unit 312, an RF module 314, memory 316, and non-volatile memory 318. The power management unit 310 receives input power from input power source 329 and, if necessary, converts the power to a format suitable for other devices. In the embodiment in which the mobile control unit 112 is installed in a vehicle, e.g., a mass-transit vehicle such as a bus, the power is preferably 12-24 volt direct current (VDC) from either the battery (e.g., emergency power) when the vehicle is not running or the alternator when the vehicle is running.

In an embodiment, the power management unit 310 includes a DC-to-DC converter that converts the 12-24 VDC to other voltages. For example, in an embodiment, the power management unit 310 may provide the RF module 314 with a 3.3 VDC power supply and provide the master control unit 312 with a 3.5 VDC and/or a 5 VDC power supply as illustrated in FIG. 3. Other voltages may be used.

Furthermore, the power management unit 310 preferably performs a power savings function to limit or reduce power consumption during low power states. Low power states may occur, for example, when the vehicle is not running and the power is being supplied from the battery. The power savings function is described in greater detail below with reference to FIG. 7.

The master control unit 312 is communicatively coupled to the RF module 314, memory 316, non-volatile memory 318, and a peripheral interface bus 331. The master control unit 312 is preferably configured to perform instructions stored in the non-volatile memory 318. In a preferred embodiment, master control unit 312 comprises a micro-controller having on-chip flash memory that provides non-volatile memory for storing program instructions and data.

In operation, the master control unit 312 interacts with the RF module 314 to send and receive data and/or commands. The memory 316 acts as a temporary data storage and buffer for the master control unit 312 during the transmission and reception of data and/or commands. The memory 316 may also provide storage during program operation. Data received via the RF module 314 may be stored in the non-volatile memory 318 for data backup purposes.

The master control unit 312 further interacts with an operator control unit 330 via the peripheral interface bus 331. The operator control unit 330 controls one or more displays 332 that may be utilized to display any type of information that a person traveling on the vehicle may find useful. In an embodiment, the information includes route information, such as the destination(s) and route-specific information. Route-specific information may include, for example, advertising, points of interest along the intended route, information pertaining to the route or objects along the intended route. For example, route-specific information may include advertisements from vendors along the intended route or in the general area of the intended route.

It should be noted that the operator control unit 330 may be coupled to a keyboard or other input device (not shown) to allow an operator to directly enter additional or alternative information for display. It should also be noted that the master control unit 312 may interface directly with other modules, such as a display 334. This embodiment may be particularly useful when multiple displays are available, such as one or more displays for route information and another display for advertising information. In this situation, it may be desirable that the displays for route information be coupled to the operator control unit 330 to allow the operator to select the appropriate information and/or to enter additional information. The advertising display, e.g., display 334, may be controlled directly by the master control unit 312.

The master control unit 312 may also interface with other devices via the peripheral interface bus 331, such as maintenance device 336. In an embodiment, the maintenance device 336 is communicatively coupled to the mobile control unit 112 via an RS-232 serial link for connecting a debug and maintenance terminal. The maintenance device 336 may examine memory, perform debug/performance tests, retrieve log files, or the like.

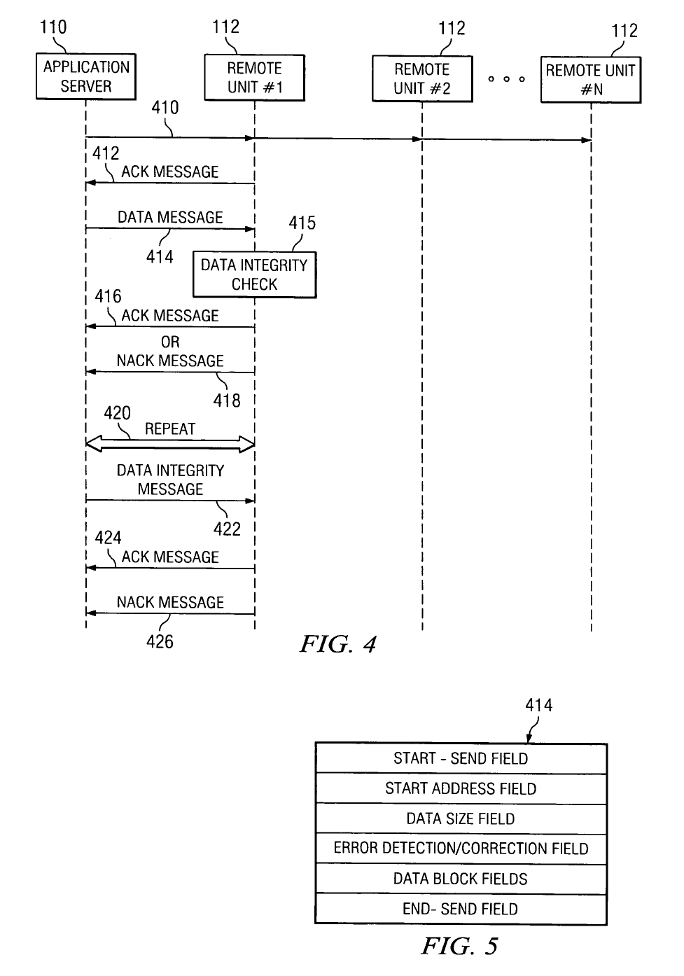

FIG. 4 is a message flow diagram illustrating the operation of an embodiment of the present invention. The message flow diagram illustrates the messages that may be transmitted between the application server 110 and one or more mobile control units 112, e.g., remote unit #1, remote unit #2, and remote unit #N illustrated in FIG. 4. Initially, the application server 110 broadcasts a polling message 410 to the vehicles, e.g., remote unit #1, remote unit #2, and remote unit #N. The polling message 410 may be broadcast to multiple remote units simultaneously or sequentially. For example, the application server 110 may transmit a message to each specific remote unit using a specific identifier that may be used to identify the intended recipient. In another embodiment, the application server 110 may broadcast a general message that all remote units may be able to receive and interpret as a polling message.

In response, the remote unit #1 transmits an acknowledgement message 412 to the application server 110. The acknowledgement message 412 contains an identifier that identifies the particular wireless interface unit responding to the polling message 410. In this manner, the application server 110 is aware of the wireless interface units that are within reception range and available for downloading new and/or additional information.

If new or additional information is available for download, then the application server 110 proceeds to download the data to the remote unit #1 via a data message 414. In a preferred embodiment, the data is encrypted to provide secure data transmission and reception, and to prevent unauthorized downloading of information to the mobile control units 112. In an embodiment, the RF module 314 of the mobile control unit 112 (FIG. 3) includes a unique identifier. The unique identifier may be used as a key by the application server 110 and the mobile control unit 112 to encrypt and decrypt messages.

After the data message 414 is received by the mobile control unit 112, a data integrity check is performed. In an embodiment, the data message transmitted by the application server 110 comprises a start-send field, a start address field, a data size field, an error detection/correction field, data block fields, and an end-send field. (An illustration of a data message that may be used in accordance with an embodiment of the present invention is illustrated in FIG. 5.) The start-send field indicates to the wireless interface unit the start of a new message. As indicated above, the start-send field preferably identifies a specific mobile control unit 112 to which the message is destined, preferably using the unique identifier of the RF module 314. The start address field may be either an absolute address or an offset, preferably given in a number of bytes or words. The data size field provides the number of bytes in the data block field. The error detection/correction field provides a method for the mobile control unit 112 to verify that the data was received accurately. The error/detection field may use, for example, a checksum value, a cyclical redundancy check (CRC), or the like. The data block fields are preferably encrypted and compressed. After the data block field is transmitted, the end-send field is transmitted to indicate the end of the transmission.

Referring now back to FIG. 4, either an acknowledgement (ACK) message 416 or a no acknowledgement (NACK) message 418 is transmitted by the mobile control unit 112 to the application server 110. The ACK message 416 is transmitted if the data integrity check 415 indicated that the data was received without error. Otherwise, the mobile control unit 112 transmits the NACK message 418. In the case that the NACK message 418 is transmitted by the mobile control unit 112, the application server 110 responds by resending the data message 414.

In some situations, the data being transmitted to the mobile control unit 112 may be quite lengthy, particularly in the situation in which advertising and/or pictures are being transmitted to the mobile control unit 112. In these situations, it may be desirable to transmit the data in smaller blocks and to reassemble the data in the mobile control unit 112. Accordingly, message 420 indicates that the data transfer may be repeated one or more times for multiple blocks.

After transmitting all of the blocks, the application server 110 preferably transmits a data integrity message 422, which is utilized to perform a data integrity message on the entire data transfer. By performing a data integrity check 415 on the entire message, problems encountered during the reassembling process may be detected. For example, performing a data integrity check 415 on each block may not detect a completely missing block or if an error occurred and data was corrupted during the reassembling process.

In response, the mobile control unit 112 transmits either an ACK message 424 if all of the data is received without an error or a NACK message 426 if an error occurred. In the event that an error occurred, it is preferred to repeat the entire process, re-transmitting all of the data blocks.

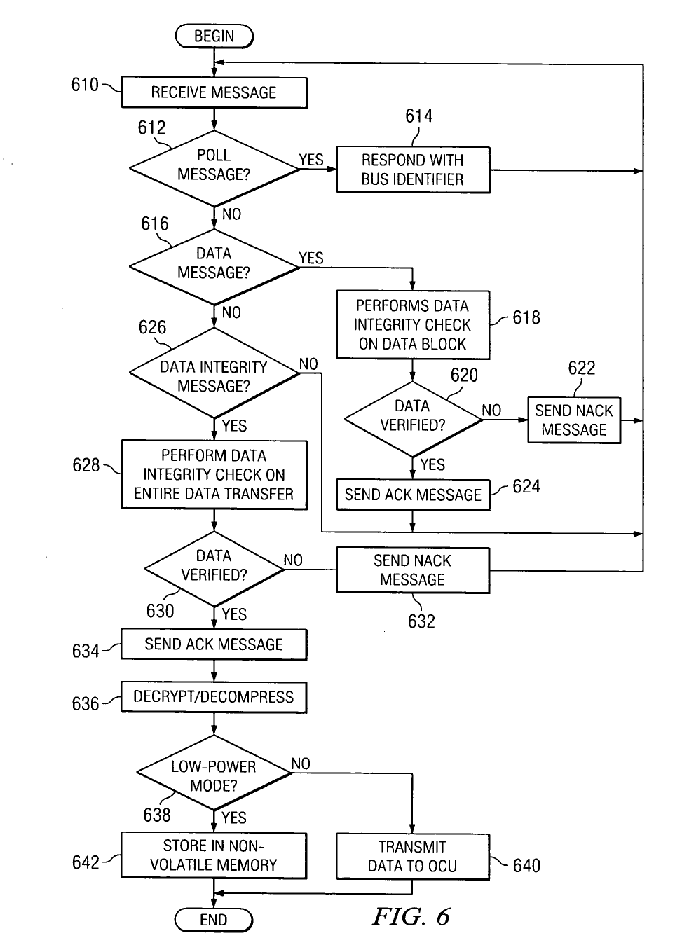

FIG. 6 is a data flow diagram illustrating steps that may be performed by the mobile control unit 112 to receive data from the application server 110 in accordance with an embodiment of the present invention. The process begins in step 610, wherein the mobile control unit 112 receives a message from the application server 110. In step 612, the mobile control unit 112 makes a determination whether or not the message is a polling message. If the mobile control unit 112 determines that the message is a polling message, then the process proceeds to step 614, wherein the mobile control unit 112 responds to the polling message by transmitting a message including the unique identifier assigned to the mobile control unit 112, such as the RF module identifier. Thereafter, the process returns to step 610 to wait for another message to be received from the application server 110.

If, in step 612, a determination is made that the message received was not a polling message, then processing proceeds to step 616, wherein a determination is made whether or not the message received is a data message. If a determination is made that the message is a data message, then processing proceeds to step 618 to perform a data integrity check on the data received in the message.

In step 620, a determination is made whether or not the data integrity check passed. If the data integrity check indicated that an error occurred, then processing proceeds to step 622, wherein the mobile control unit 112 transmits a NACK message. Otherwise, processing proceeds to step 624, wherein an ACK message is transmitted. After step 622 or step 624, processing returns to step 610 to receive the next message.

If, in step 616, a determination is made that the message received is not a data message, then processing proceeds to step 626, wherein a determination is made whether or not the message is a data integrity message. As discussed above, a data integrity message may be transmitted by the application server 110 after transmitting one or more data messages to ensure that all of the data messages were received and received accurately. If a determination is made in step 626 that the message was not a data integrity message, then processing returns to step 610 to receive a next message. If a determination is made that the message was an integrity message, then processing proceeds to step 628, wherein a data integrity function is performed to verify that all of the data blocks have been received and received accurately.

In step 630, a determination is made to determine whether or not the data integrity function indicated that an error occurred. If the data integrity function indicated that an error occurred, then processing proceeds to step 632, wherein a NACK message is transmitted by the mobile control unit 112 and then returns to step 610 to receive the next message. It should be noted that it is preferred that the entire process be repeated in this situation in which the data integrity check performed in step 628 indicated an error. If, in step 630, a determination is made that all of the data was received accurately, then processing proceeds to step 634, wherein an ACK message is transmitted by the mobile control unit 112.

Thereafter, in step 636, the data is decompressed and decrypted, if necessary. As discussed above, the data may be compressed to provide smaller block size for transfer. Additionally, the data may be encrypted to provide secure data transmission between the transmitting and receiving units. In these situations, it may be necessary to decrypt and/or decompress the data upon receipt as indicate in step 636.

In step 638, a determination is made whether or not the system is in a low-power mode. If the system is in a low-power mode, then other components such as the operator control unit 330 may not be operating, e.g., the operator control unit 330 may be powered off. In these situations, it may be desirable to store the data in local non-volatile memory, such as flash memory. Accordingly, if in step 638 a determination is made that the system is not in low-power mode, then processing proceeds to step 640, wherein the master control unit 312 of the mobile control unit 112 transfers data stored in the non-volatile memory 318 and/or memory 316 to the operator control unit 330 for display purposes. Furthermore, the data may be retained in the non-volatile memory 318 and/or memory 316 for back-up purposes and/or display to other devices, e.g., display 334.

If, in step 638, a determination is made that the system is in a low-power mode, then processing may proceed to step 642, wherein the data may be stored in non-volatile memory, such as flash memory. The data stored in non-volatile memory may be transmitted to the operator control unit 330 at a later time when the operator control unit 330 is in a powered state.

FIG. 7 is a data flow diagram illustrating steps that may be performed by the mobile control unit 112 to conserve power in accordance with an embodiment of the present invention. Initially, the mobile control unit 112 is in a sleep mode, which may be entered, for example, upon detecting that emergency battery power is being used to power the mobile control unit 112. In an embodiment, entering the sleep mode is delayed for a predetermined amount of time, preferably between about 5 minutes and about 30 minutes, after detecting the use of emergency power.

The process begins in step 710, wherein a low power mode is entered. In the low power mode, the mobile control unit 112 applies limited power to selected modules of the mobile control unit 112 such that the mobile control unit 112 is capable of determining whether or not the application server 110 has sent a message to the mobile control unit 112. In an embodiment, this may comprise supplying limited power to the RF module 314 and the master control unit 312. It should be noted that the RF module 314 and master control unit 312 may be capable of operating with less than full power. For example, the master control unit 312, which during normal operations may require 5 VDC, may only require 3.5 VDC to check for the existence of messages transmitted by the application server 110.

After entering the low power mode in step 710, processing proceeds to step 712, wherein a determination is made whether or not a message has been received from the application server 110. If a determination is made that a message has not been received from the application server 110, then processing proceeds to step 714, wherein a timer is initialized to a predetermined value, preferably between about one second to about one minute. In step 716, the mobile control unit 112 enters a sleep mode. In the sleep mode, power to the master control unit 312 is disconnected. The loop at step 718 then waits for the timer to expire. If a determination is made at step 718 that the timer has expired, then processing proceeds to step 710, wherein the low power mode is entered, thereby enabling the mobile control unit 112 to determine if a message has yet been transmitted by the application server.

If, in step 712, a determination is made that a message has been received, then processing proceeds to step 720, wherein the mobile control unit 112 receives data messages from the application server 110. The data may be received in a series of messages as discussed above, or in a single message. The data may be received in accordance with the process described above with reference to FIG. 6.

It should be appreciated that the process described above allows the mobile control unit 112 to enter a low power consumption mode to determine if the application server 110 is trying to communicate with the mobile control unit 112 and if so, to automatically apply power to the components necessary to receive the data. In this manner, the mobile control unit 112 may conserve power when no communications are being performed. This is particularly useful in situations in which the vehicle is not operating and power is applied from the emergency power, i.e., a battery source. One situation in which this may occur is when the vehicle is parked in a garage or parking lot over night, thereby enabling the application server to download data to the remote unit overnight when the vehicle is not operating.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing information to a mass-transit vehicle comprising:
determining whether or not the mass-transit vehicle is within a first area;
retrieving information specific to the mass-transit vehicle;
transmitting vehicle-specific information to the mass-transit vehicle;
upon receiving an acknowledgement that all information has been received accurately by the mass-transit vehicle, transmitting an error-detection message; and
upon receiving an indication that all information has not been received accurately by the mass-transit vehicle, repeating the process.

2. The method of claim 1, wherein the first area is a parking lot or a maintenance area.

3. The method of claim 1, wherein the vehicle-specific information includes route-specific information.

4. The method of claim 1, wherein the vehicle-specific information includes advertising specific to a route.

5. The method of claim 1, wherein the transmitting is performed using WiFi.

6. The method of claim 1, further comprising encrypting the vehicle-specific information.

7. The method of claim 1, further comprising compressing the vehicle-specific information.

8. A method of receiving vehicle-specific information by a mass-transit vehicle, the method comprising:
receiving a polling message when the mass-transit vehicle enters a first area;
transmitting a first message indicating that the mass-transit vehicle is within the first area, the first message identifying the mass-transit vehicle;
receiving one or more messages, each message including vehicle-specific information; and
storing the vehicle-specific information.

9. The method of claim 8, further comprising transmitting at least a portion of the vehicle-specific information to an operator control unit.

10. The method of claim 8, further comprising transmitting at least a portion of the vehicle-specific information to a display.

11. The method of claim 8, wherein the vehicle-specific information includes route information.

12. The method of claim 8, wherein the vehicle-specific information includes advertising specific to the mass-transit vehicle.

13. The method of claim 8, further comprising receiving a last message, the last message including error-detection information for detecting errors in any of the one or more messages.

14. The method of claim 13, further comprising transmitting a second message indicating that no errors were found.

15. The method of claim 13, further comprising transmitting a second message indicating that errors were found.

16. The method of claim 8, wherein the transmitting is performed using WiFi.

17. The method of claim 8, further comprising encrypting the vehicle-specific information.

18. The method of claim 8, further comprising compressing the vehicle-specific information.

19. A method of retrieving data by a mass-transit vehicle, the method comprising:
(a) entering a sleep mode for a first time period;
(b) after expiration of the first time period, entering a low power mode;
(c) determining, while in the low power mode, whether a first message has been received;
(d) if the first message has not been received, re-entering the sleep mode; and
(e) if the first message has been received, performing the steps:
entering a normal operating mode;
receiving vehicle-specific information; and
re-entering the sleep mode.

20. The method of claim 19, wherein the sleep mode is entered upon detecting that emergency power is being used.

21. The method of claim 19, wherein the sleep mode is entered after a first time period after detecting that emergency power is being used.

22. The method of claim 19, wherein the first message includes a mass-transit vehicle identifier.

23. The method of claim 19, wherein steps (a)-(d) are repeated until the first message has been received.

24. The method of claim 19, wherein the first time period is between about one second to about one minute.

25. An apparatus for transmitting information to a mobile control unit, the apparatus comprising:
a transceiver;
an application server communicatively coupled to the transceiver, the application server being configured to store instructions to cause the application server to perform the steps:
determining whether or not the mobile control unit is within a first area;
retrieving information specific to the mobile control unit;
transmitting vehicle-specific information to the mobile control unit;
upon receiving an acknowledgement that all information has been received accurately by the mobile control unit, transmitting an error-detection message; and
upon receiving an indication that all information has not been received accurately by the mobile control unit, repeating the process.

26. The apparatus of claim 25, wherein the first area is a parking lot or a maintenance area.

27. The apparatus of claim 25, wherein the vehicle-specific information includes route-specific information.

28. The apparatus of claim 25, wherein the vehicle-specific information includes advertising specific to a route.

29. The apparatus of claim 25, wherein the transmitting is performed using WiFi.

30. The apparatus of claim 25, wherein the application server is further configured for encrypting the vehicle-specific information.

31. The apparatus of claim 25, wherein the application server is further configured for compressing the vehicle-specific information.

32. An apparatus for receiving vehicle-specific information by a mass-transit vehicle, the apparatus comprising:
a transceiver;
a control unit communicatively coupled to the transceiver;
memory communicatively coupled to the control unit, the memory being configured to store instructions to cause the control unit to perform the steps:
receiving a polling message when the mass-transit vehicle enters a first area;
transmitting a first message indicating that the mass-transit vehicle is within the first area, the first message identifying the mass-transit vehicle;
receiving one or more messages, each message including vehicle-specific information; and
storing the vehicle-specific information.

33. The apparatus of claim 32, wherein the memory is further configured to store instructions to cause the control unit to perform the step of transmitting at least a portion of the vehicle-specific information to an operator control unit.

34. The apparatus of claim 32, wherein the memory is further configured to store instructions to cause the control unit to perform the step of transmitting at least a portion of the vehicle-specific information to a display.

35. The apparatus of claim 32, wherein the vehicle-specific information includes route information.

36. The apparatus of claim 32, wherein the vehicle-specific information includes advertising specific to the mass-transit vehicle.

37. The apparatus of claim 32, wherein the memory is further configured to store instructions to cause the control unit to perform the step of receiving a last message, the last message including error-detection information for detecting errors in any of the one or more messages.

38. The apparatus of claim 37, wherein the memory is further configured to store instructions to cause the control unit to perform the step of transmitting a second message indicating that no errors were found.

39. The apparatus of claim 37, wherein the memory is further configured to store instructions to cause the control unit to perform the step of transmitting a second message indicating that errors were found.

40. The apparatus of claim 32, wherein the transmitting is performed using WiFi.

41. The apparatus of claim 32, wherein the memory is further configured to store instructions to cause the control unit to perform the step of encrypting the vehicle-specific information.

42. The apparatus of claim 32, wherein the memory is further configured to store instructions to cause the control unit to perform the step of compressing the vehicle-specific information.

43. An apparatus for receiving vehicle-specific information by a mass-transit vehicle, the apparatus comprising:
a transceiver;
a control unit communicatively coupled to the transceiver;
memory communicatively coupled to the control unit, the memory being configured to store instructions to cause the control unit to perform the steps:
(a) entering a sleep mode for a first time period;
(b) after expiration of the first time period, entering a low power mode;
(c) determining, while in the low power mode, whether a first message has been received;
(d) if the first message has not been received, re-entering the sleep mode; and
(e) if the first message has been received, performing the steps:
entering a normal operating mode;
receiving vehicle-specific information; and
re-entering the sleep mode.

44. The apparatus of claim 43, wherein the sleep mode is entered upon detecting that emergency power is being used.

45. The apparatus of claim 43, wherein the sleep mode is entered after a first time period after detecting that emergency power is being used.

46. The apparatus of claim 43, wherein the first message includes a mass-transit vehicle identifier.

47. The apparatus of claim 43, wherein the memory is further configured to store instructions to cause the control unit to repeat steps (a)-(d) until the first message has been received.

48. The apparatus of claim 43, wherein the first time period is between about one second to about one minute.
